(19) United States
(12) Patent Application Publication
(10) Pub. No.: US 2015/0254024 A1
(43) Pub. Date: Sep. 10, 2015

(54) USING PRESET COMBINATION OF PAGE EXCEPTION PRINT SETTINGS TO ESTABLISH EXCEPTION PAGES WITHIN DOCUMENTS

(71) Applicant: XEROX CORPORATIO, Norwalk, CT (US)

(72) Inventor: GREGORY M. FRUIN, WEBSTER, NY (US)

(73) Assignee: XEROX CORPORATION, Norwalk, CT (US)

(21) Appl. No.: 14/199,508

(22) Filed: Mar. 6, 2014

(51) Int. Cl. G06F 3/12

(52) U.S. Cl. CPC G06F 3/1204; G06F 3/1257

(57) ABSTRACT

Methods and systems provide exception shortcut keywords, each of which identifies a preset combination of exception print settings containing a unique combination of print media, printing color, printing image quality, and simplex/duplex controls, etc., that are different from the document print settings, and from the other preset combinations. In response, these methods and systems receive an exception shortcut keyword for at least one of the sections. This causes these methods and systems to automatically change print settings of corresponding sections to the preset combination of exception print settings. All the setting changes associated with a selected preset combination of exception print settings are made in response only to receiving a single exception shortcut keyword.

### BACKGROUND

Systems and methods herein generally relate to print drivers and more particularly to print drivers that provide page exception print settings.

Page exceptions or overrides allow a user to override the job level print settings for specified pages in a document to be printed (e.g., a “print document”) such as media attributes (e.g., paper size, paper type, paper color), color correction, image shift, etc. Page overrides can be programmed at the device or via a client such as a job submission application or print driver. Page exceptions are established for a specific page number, set of page numbers, or range of page numbers along with the desired settings for those pages, and these settings override the settings used for the rest of the job.

Page overrides are a powerful feature, but creating customized print settings for specific pages in a print document is difficult in conventional systems because the user is asked to manually remember the page numbers of every page of the document to which the special print settings will be applied. Therefore, conventional systems ask the user to program page overrides in small batches, save the settings, and return to the document to determine the next set of special print settings. With conventional systems, users sometimes write down all affected pages and their associated special print settings prior to entering the driver user interface. For example, some users find it easier to simply print the entire document without page overrides, and then refer to the printed document (and associated annotations/notes) when programming page overrides in the driver user interface.

To complicate matters even further, programming page overrides for jobs containing different sizes with duplex (2-sided) printing can result in a blank image being inserted on the back side of a page prior to the print media size change, which can make it extremely difficult for a user to determine which page numbers to use later in the document, as they attempt to account for the injected blank pages in their calculations. In a single job there could be dozens of page overrides that were meticulously configured, which is most common in production and graphics arts environments.

One of the biggest challenges from a user experience perspective with page overrides is using them for documents that change over time. Page overrides are only accurate until document revisions cause the pagination of the source document to change. When the pagination changes, the page overrides need to be updated to reflect changes in page numbers, which can be very cumbersome.

### SUMMARY

Various methods herein receive an identification of one or more sections of a print document into a graphic user interface. At this point, the print document has at least some document print settings, which may be just default settings, or may be customized settings; however, such settings are applied to the entire document (until exception/override settings are set for some of the document, and then those overrides are applied in place of the original print settings).

These methods provide exception shortcut keywords from a print driver through a graphic user interface for the user to select. Each of the exception shortcut keywords identifies a preset combination of exception print settings maintained by the print driver, each of the preset combination of exception print settings contains a unique combination of print media, printing color, color correction, image shift, printing image quality, and/or simplex/duplex controls, etc., that are different from the document print settings, and from the other preset combinations of exception print settings.

The exception shortcut keywords can be provided (and responses thereto received) through an application used to create and/or edit the print document (e.g., word processor, graphic design program, spreadsheet, etc.); or through a print job submission application (e.g., print driver, print server, finisher program, etc.). Further, the preset combination of exception print settings can comprise print settings that are outside those natively available in the application used to create and/or edit the print document.

In response, these methods receive an exception shortcut keyword for at least one of the sections (without asking the user to identify any page numbers within the print document) into the graphic user interface from the user. This causes these methods to automatically change print settings of corresponding ones of the sections of the print document to corresponding ones of the preset combination of exception print settings. It is notable that all the setting changes associated with a selected preset combination of exception print settings are made in response only to receiving the single exception shortcut keyword for that document section.

After the preset combination of exception print settings are set for one or more sections of the document, these methods print the print document using a printing device that is operatively connected to the processor. During the printing, such methods use the document print settings for pages of the print document that are outside the sections, and use the preset combination of exception print settings for pages of the print document within the sections.

Systems herein include, among other elements, a graphic user interface receiving identification of sections of a print document, a processor operatively (meaning directly or indirectly) connected to the graphic user interface, and a printing device operatively connected to the processor. The print document has document print settings; however, the graphic user interface provides exception shortcut keywords from a print driver. Each of the exception shortcut keywords identifies a preset combination of exception print settings, each of the preset combination of exception print settings is different from the document print settings, and each different one of the preset combination of exception print settings maintained by the print driver comprises a different combination of print media, printing color, color correction, image shift, printing image quality, and/or simplex/duplex controls, etc.

The graphic user interface receives, from the user, an exception shortcut keyword selection/identification (presented as menu selections) for at least one of the sections. The processor automatically changes print settings (using the print driver) of corresponding sections of the print document to the corresponding preset combination of exception print settings in response only to receiving the exception shortcut keyword menu selection from the user. The printing device prints the print document using the document print settings for pages of the print document outside the sections, and using the preset combination of exception print settings for pages of the print document within the sections.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a flow diagram of various methods herein;

FIG. 2 is a schematic diagram illustrating screens provided by methods and systems herein;

FIG. 3 is a schematic diagram illustrating screens provided by methods and systems herein;

FIG. 4 is a schematic diagram illustrating screens provided by methods and systems herein;

FIG. 5 is a schematic diagram illustrating systems herein;

FIG. 6 is a schematic diagram illustrating devices herein; and

FIG. 7 is a schematic diagram illustrating devices herein.

### DETAILED DESCRIPTION

As mentioned above, manually establishing page exceptions or page overrides can be very time-consuming and frustrating for users. Therefore, the systems and methods herein provide dynamic page overrides that represent an enhancement to manually selected page overrides.

In many document creation/editing applications, such as word processors, spreadsheet programs, presentation programs, graphic design programs, etc., a user can create a document containing multiple sections that are manually set to use print media of varying sizes, types (such as envelopes), or paper source selections (such as “tray 3”). The systems and method herein provide a print driver that supplements the document creation/editing application with highly customized print setting values that might not otherwise be available through the document creation/editing applications alone. These customized print setting values are selected using predefined page exception shortcut “keywords” that the user can then associate with page overrides defined in the driver.

More specifically, with systems and methods herein, a user operates a document creation/editing application to create a page or section break, and then chooses a dynamic page override page exception keyword from the menu selection through which paper sources are presented for that page or section. Rather that specifying a page number or range, with the systems and methods herein, the user chooses a dynamic page override page exception keyword for a limited section (defined by section breaks and/or page breaks) in the document. The user follows the same procedure to assign customized print setting values to additional sections in the document. The user can reuse a specific dynamic page override page exception keyword a number of times in the same document, or use different dynamic page override page exception keywords in different portions of the document.

With the systems and methods herein, the print driver can resolve and inject the job ticket settings for each of the dynamic page overrides such that the job ticket is consistent with the existing ticket format. In another option, the systems and methods herein send the dynamic page overrides settings to the printing device and the printing device resolves and applies the appropriate settings when it encounters a page containing the associated page exception keyword.

Such dynamic page overrides greatly simplify the user experience related to page overrides, especially for complex jobs that ask users to spend a significant amount of time programming the page overrides. Also, these dynamic page overrides avoid the need to manually update page numbers and ranges in the print driver user interface to account for pagination changes because such dynamic page overrides are based upon sections of the documents, and not specific page numbers.

Therefore, the systems and method herein eliminate many sources of frustration for programming page overrides. Rather than needing to determine or recall the affected page numbers, or update settings later as the document content grows or shrinks; with systems and method herein, the user only chooses a dynamic page override page exception keyword for a section in the document creation/editing application. The driver then dynamically determines on which pages to apply the exception print settings at the time of printing.

The systems and methods herein also extend the range of print settings that are available through document creation/editing applications, which generally only provide the user very straightforward exception print settings such as media size, type, or tray, color vs. black and white, duplex/simplex, draft mode, etc. To the contrary, the systems and methods herein provide print drivers that offer highly complex print settings including many different tone reproduction curves, highly granular image quality selections, etc., not available through the limited menu choices provided by the document creation/editing application alone.

Thus, while the document creation/editing application may be able to provide a very limited number of print settings on its own, systems and methods herein provide a full range of advanced page level features that would otherwise only be available by manually configuring page overrides. Further, such complex print settings are offered to the user as preset combinations of settings that have been determined previously to successfully work together, which allows the user to select multiple settings known to be successful combinations of settings using a single keyword (not requiring the user to take any other action beyond selecting the single keyword).

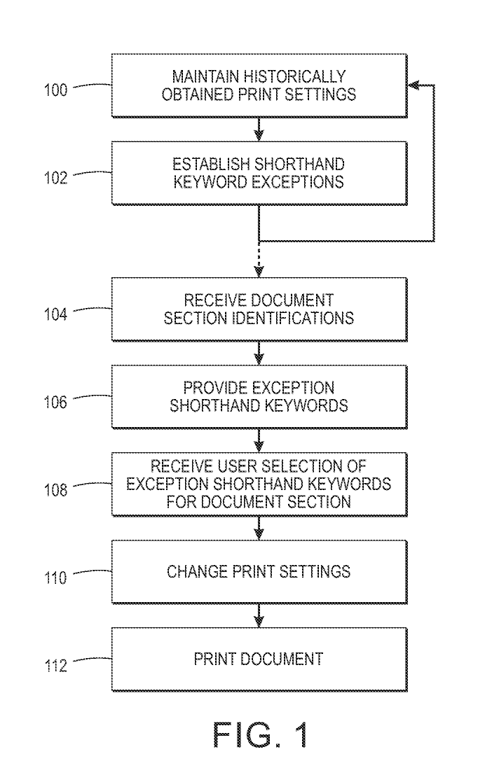

FIG. 1 is flowchart illustrating exemplary methods herein. As shown in item 100, these methods maintain files (or databases) of different historically manually developed combinations of print settings (combination of print media, printing color, color correction, image shift, printing image quality, and simplex/duplex controls, etc.,) that are known to successfully produce a specific result. Such combinations of print settings may have been established in the past (and may have been adjusted and refined over time through trial and error) and are known to work well together and to produce a specific and desirable result.

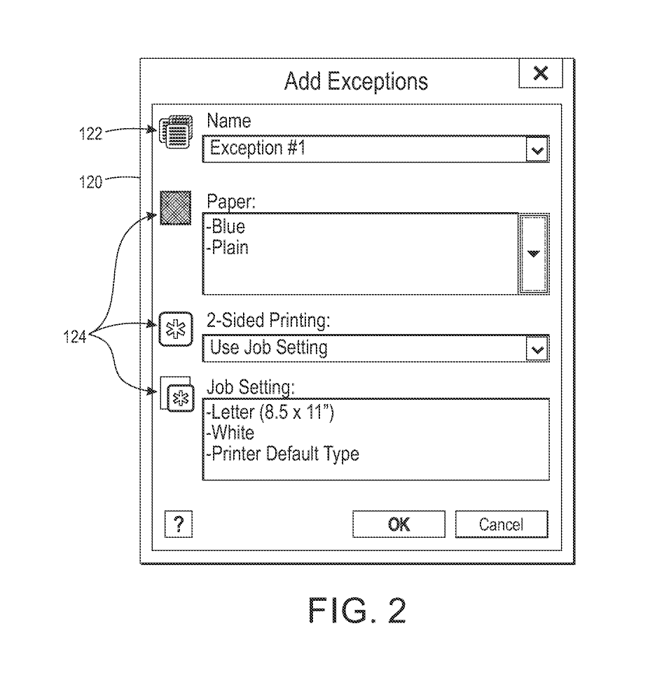

With this historical information of successfully utilized combinations of print settings, in item 102 the systems and methods herein allow very sophisticated (and casual) users to establish named print exceptions. An exemplary screenshot for establishing exception shortcut keywords and associated preset combinations of exception print settings presented to users is shown in FIG. 2 as item 120. As shown in FIG. 2, the user can be provided with a field 122 where they can enter (in free-form text, or in structured text) the name of a new print exception being created (which is commonly referred to herein as the exception shortcut keyword). With respect to the structured text entered into field 122, the name of the exception may come from a limited set of predefined keywords from which the user selects, depending primarily on technical limitations with the interface between the driver and calling application. Further, fields 124 allow the user to specify a specific combination of print settings. In FIG. 2, the user can define a unique combination of print media, printing color, color correction, image shift, printing image quality, and/or simplex/duplex controls, etc., as well other job settings (as shown by items 124). As would be understood by those ordinarily skilled in the art, FIG. 2 only illustrates an exemplary screenshot and many additional fields 124 could be provided by the systems and methods herein to allow the user to specify many more print settings, including finisher settings, etc.

The processing in item 102 in FIG. 1 saves the name (as the new exception shortcut keyword) and all the job settings associated with the specific exemption/override established by the user. Further, the processing in item 102 can be repeated many times (as shown by the return arrow) to create and store many exception shortcut keywords. Further, the dashed arrow from item 102 indicates that there can be a large time lag until any following steps in the flow are utilized, and that the processing in the later portions of the flowchart do not need to start with items 100-102, but processing can be started independently at, for example, the document section identification in item 104.

Some popular document creation/editing applications (and print/finishing job submission applications and print drivers) provide the user the option to divide a document into sections (that are not necessarily tied to specific page numbers). Therefore, in item 104 in FIG. 1, these methods receive, from the user, an identification of one or more sections of a print document into a graphic user interface. More specifically, creating sections in a document is different than identifying page(s) or ranges of pages. Instead, sections are created by placing markers at locations within the document that are content-dependent (as opposed to being page number dependent). Therefore, a group of pages will be defined by page number (e.g., pages 5-8); while, to the contrary sections of a document are defined by section of content, such as a few paragraphs (e.g., paragraphs 12-20). The sections of a document may move to different page numbers as they change or other sections of the document change. Generally, each section is defined as the document content between a section-beginning marker and a section-end marker (or the next section-beginning marker). Document content of a section may increase or decrease and document content outside a section may increase or decrease, changing the pages number(s) of the document where the section appears and, again, this occurs because the sections of a document are document-content dependent, and not page number dependent.

At this point, the print document has at least some document print settings, which may be just default settings, or may be customized settings; however, such settings are global settings that are applied to the entire document (until exception/override settings are set for some of the document, and then those overrides are applied in place of the original print settings).

As shown in item 106, these methods provide exception shortcut keywords from a print driver through a graphic user interface for the user to select. The exception shortcut keywords can be provided (and responses thereto received) through an application used to create and/or edit the print document (e.g., word processor, graphic design program, spreadsheet, etc.); or through a print job submission application used with the print document or after the print document has been previously created (e.g., print driver, print server, finisher program, etc.). Further, the preset combination of exception print settings can comprise print settings that are outside those natively available in the application used to create and/or edit the print document.

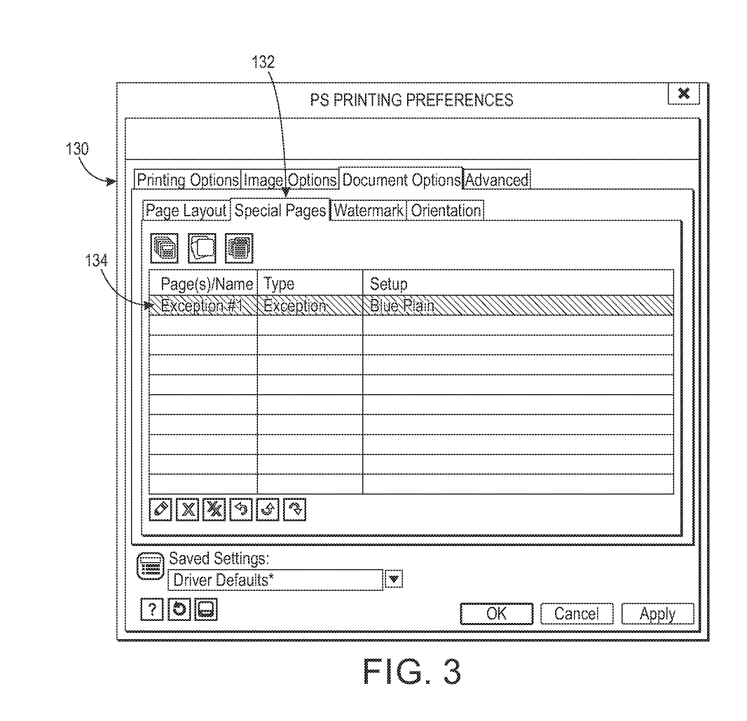

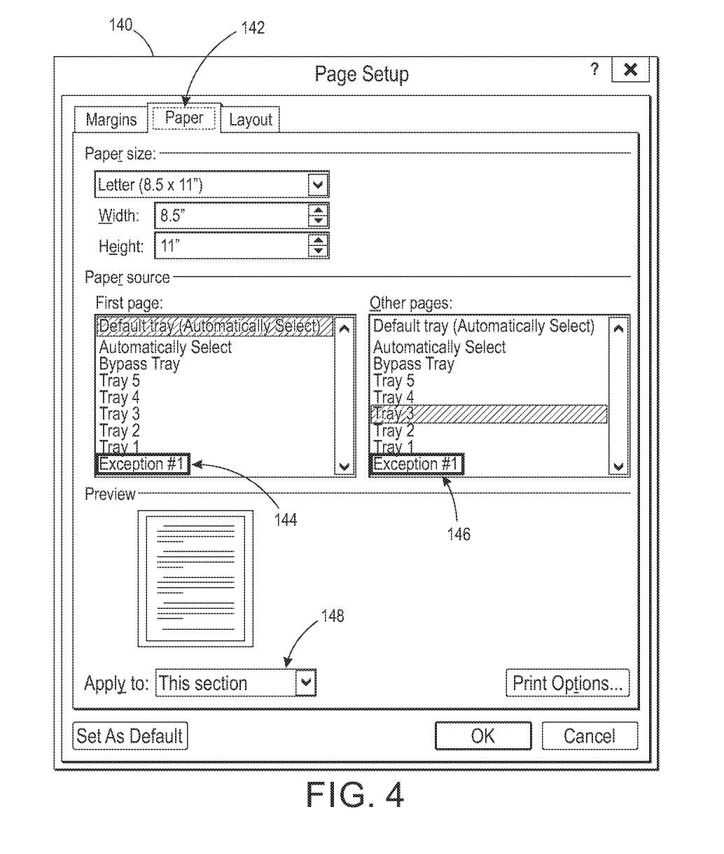

Two exemplary ways that the page exemption shortcut keywords can be provided to the user are shown in FIGS. 3 and 4. One ordinarily skilled in the art would understand that FIGS. 3 and 4 are only examples and that the systems and methods herein could utilize many different formats to present the exception shortcut keywords to the user. More specifically, FIG. 3 illustrates a screenshot 130 that may be provided through a job submission application and includes a “special pages” tab 132 that lists a number of previously created/stored preset combination of exception print settings identified by keywords 134 (“Exception #1” in this example). Similarly, FIG. 4 illustrates a screenshot 140 that may be illustrated through a document creation application (e.g., a word processor) for page setup that includes a “paper” tab 142. As shown, this paper tab 142 can list various exception shortcut keywords 144, 146 in the same selection menu from which different sizes of paper and paper trays are selected. Further, item 148 indicates that the exception shortcut keyword being selected applies to a specific section of the document (as opposed to specific page numbers of the document).

Each of the different exception shortcut keywords presented in item 106 identifies a different preset combination of exception print settings maintained by the print driver. Further, each of the preset combination of exception print settings contains a unique combination of print media, printing color, color correction, image shift, printing image quality, and simplex/duplex controls, etc., that are different from the document print settings, and from the other preset combinations of exception print settings.

Therefore, as shown in FIG. 4, rather than just selecting a certain paper size or paper tray, or individually selecting other print options in separate manual operations, by selecting a single exception shortcut keyword of many the exception shortcut keywords presented 144, 146 in item 106, the user automatically selects a unique combination of multiple print settings. Further, these print settings can be much more sophisticated than those offered by the document creation program and/or job submission application because they can contain very specific finely tuned historical settings developed from previously processed print jobs.

Document creation/job submission applications usually only allow the user a limited number of print settings (so as to reduce user confusion, maintain simplicity in programming sophistication, etc.). For example, a document creation/job submission application may offer three color quality settings (low, medium, and high). However, because the systems and methods herein allow the creation of an unlimited level of sophistication of print settings in items 100 and 102, the print settings available through selection of the exception shortcut keywords has a greater range of print settings and sophistication of print settings relative to those preset print settings available through the document creation/job submission applications. Thus, there can be hundreds (or even thousands) of different print qualities offered in the different preset combinations of exception print settings implemented through the exception shortcut keywords.

In response, these methods receive an exception shortcut keyword for at least one of the sections of the document in item 108 (without asking the user to identify any page numbers within the print document) into the graphic user interface from the user. This causes these methods to automatically change print settings of corresponding ones of the sections of the print document to corresponding ones of the preset combination of exception print settings in item 110. It is notable that all the setting changes associated with a selected preset combination of exception print settings are all automatically made in response to just receiving a single exception shortcut keyword from a user for a given document section in item 108. Further, such setting changes in item 110 can be made using the print driver operating through a processor that is operatively (meaning directly or indirectly) connected to the graphic user interface.

After the preset combination of exception print settings are set for one or more sections of the document, these methods print the print document in item 112 using a printing device that is operatively connected to the processor. During the printing in item 112, such methods automatically use the document print settings for pages of the print document that are outside the sections, and automatically use the preset combination of exception print settings for pages of the print document within the sections.

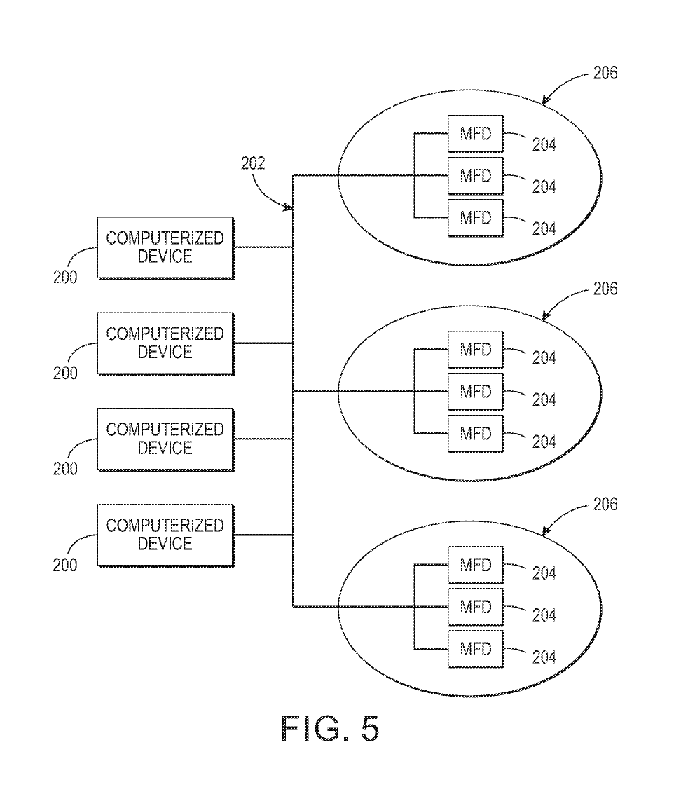

As shown in FIG. 5, exemplary systems and methods herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

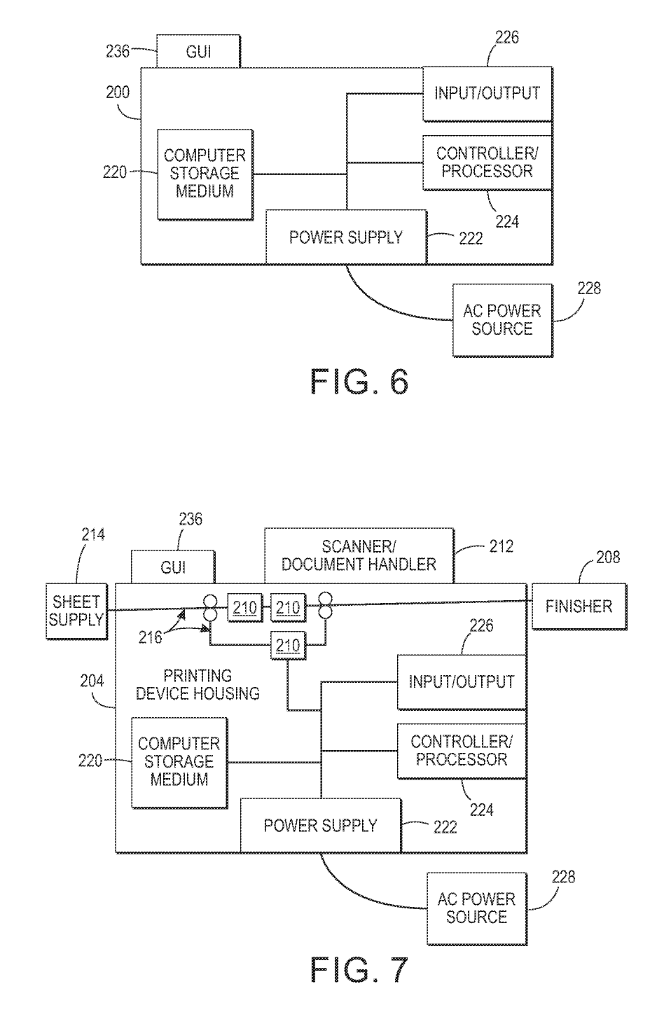

FIG. 6 illustrates a computerized device 200, which can be used with systems and methods herein and can comprise, for example, a print server, a personal computer, a portable computing device, etc. The computerized device 200 includes a controller/processor 224 and a communications port (input/output) 226 operatively connected to the processor 224 and to the computerized network 202 external to the computerized device 200. Also, the computerized device 200 can include at least one accessory functional component, such as a graphic user interface assembly 236 that also operate on the power supplied from the external power source 228 (through the power supply 222).

The input/output device 226 is used for communications to and from the computerized device 200. The processor 224 controls the various actions of the computerized device. A non-transitory computer storage medium device 220 (which can be optical, magnetic, capacitor based, etc.) is readable by the processor 224 and stores instructions that the processor 224 executes to allow the computerized device to perform its various functions, such as those described herein. Thus, as shown in FIG. 6, a body housing has one or more functional components that operate on power supplied from an alternating current (AC) source 228 by the power supply 222. The power supply 222 can comprise a power storage element (e.g., a battery, etc).

FIG. 7 illustrates a computerized device that is a printing device 204, which can be used with systems and methods herein and can comprise, for example, a printer, copier, multi-function machine, multi-function device (MFD), etc. The printing device 204 includes many of the components mentioned above and at least one marking device (printing engines) 210 operatively connected to the processor 224, a media path 216 positioned to supply sheets of media from a sheet supply 214 to the marking device(s) 210, etc. After receiving various markings from the printing engine(s), the sheets of media can optionally pass to a finisher 208 which can fold, staple, sort, etc., the various printed sheets. Also, the printing device 204 can include at least one accessory functional component (such as a scanner/document handler 212, etc.) that also operate on the power supplied from the external power source 228 (through the power supply 222).

Therefore, systems herein include, among other elements, a graphic user interface 236 receiving identification of sections of a print document, a processor 224 operatively connected to the graphic user interface 236, and a printing device 204 operatively connected to the processor 224. The print document has document print settings; however, the graphic user interface 236 provides exception shortcut keywords from a print driver. Each of the exception shortcut keywords identifies a preset combination of exception print settings, each of the preset combination of exception print settings is different from the document print settings, and each different one of the preset combination of exception print settings maintained by the print driver comprises a different combination of print media, printing color, color correction, image shift, printing image quality, and simplex/duplex controls, etc.

The graphic user interface 236 receives, from the user, an exception shortcut keyword selection/identification (presented as menu selections) for at least one of the sections. The processor 224 automatically changes print settings (using the print driver) of corresponding sections of the print document to the corresponding preset combination of exception print settings in response only to receiving the exception shortcut keyword menu selection from the user. The printing device 204 prints the print document using the document print settings for pages of the print document outside the sections, and using the preset combination of exception print settings for pages of the print document within the sections.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, processors, etc.) are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes. Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A method comprising:
receiving identification of sections of a print document into a graphic user interface, said print document having document print settings, and said receiving identification of said sections being performed without identification of page numbers within said print document;
providing exception shortcut keywords through a graphic user interface, each of said exception shortcut keywords identifying a preset combination of exception print settings, and each of said preset combination of exception print settings being different from said document print settings;
receiving an exception shortcut keyword for at least one of said sections, without identification of page numbers, into said graphic user interface, providing dynamic section-based page override page exception independent of page numbers;
automatically changing print settings of corresponding ones of said sections of said print document to corresponding ones of said preset combination of exception print settings in response only to said receiving said exception shortcut keyword, using a processor operatively connected to said graphic user interface; and
printing said print document using a printing device operatively connected to said processor,
during said printing, using said document print settings for pages of said print document outside said sections, and using said preset combination of exception print settings for pages of said print document within said sections.

2. The method according to claim 1, said providing said exception shortcut keywords and said receiving said exception shortcut keyword appearing in an application used to one of create and edit said print document.

3. The method according to claim 2, said preset combination of exception print settings comprising print setting outside those natively available in said application used to one of create and edit said print document.

4. The method according to claim 1, said providing said exception shortcut keywords and said receiving said exception shortcut keyword appearing in a print job submission application used after said print document has been previously created.

5. (canceled)

6. A method comprising:
receiving identification of sections of a print document into a graphic user interface, said print document having document print settings, and said receiving identification of said sections being performed without identification of page numbers within said print document;
providing exception shortcut keywords from a print driver through a graphic user interface, each of said exception shortcut keywords identifying a preset combination of exception print settings maintained by said print driver, each of said preset combination of exception print settings being different from said document print settings, and each different one of said preset combination of exception print settings comprising a different combination of print media, printing color, color correction, image shift, printing image quality, and simplex/duplex controls;
receiving an exception shortcut keyword for at least one of said sections, without identification of page numbers, into said graphic user interface, providing dynamic section-based page override page exception independent of page numbers;
automatically changing print settings of corresponding ones of said sections of said print document to corresponding ones of said preset combination of exception print settings in response only to said receiving said exception shortcut keyword, using said print driver operating through a processor operatively connected to said graphic user interface; and
printing said print document using a printing device operatively connected to said processor,
during said printing, using said document print settings for pages of said print document outside said sections, and using said preset combination of exception print settings for pages of said print document within said sections.

7. The method according to claim 6, said providing said exception shortcut keywords and said receiving said exception shortcut keyword appearing in an application used to one of create and edit said print document.

8. The method according to claim 7, said preset combination of exception print settings comprising print setting outside those natively available in said application used to one of create and edit said print document.

9. The method according to claim 6, said providing said exception shortcut keywords and said receiving said exception shortcut keyword appearing in a print job submission application used after said print document has been previously created.

10. (canceled)

11. A system comprising:
a graphic user interface receiving identification of sections of a print document, said receiving identification of said sections being performed without identification of page numbers within said print document;
a processor operatively connected to said graphic user interface; and
a printing device operatively connected to said processor,
said print document having document print settings,
said graphic user interface providing exception shortcut keywords,
each of said exception shortcut keywords identifying a preset combination of exception print settings,
each of said preset combination of exception print settings being different from said document print settings,
said graphic user interface receiving an exception shortcut keyword for at least one of said sections without identification of page numbers, providing dynamic section-based page override page exception independent of page numbers,
said processor automatically changing print settings of corresponding ones of said sections of said print document to corresponding ones of said preset combination of exception print settings in response only to said receiving said exception shortcut keyword, and
said printing device printing said print document using said document print settings for pages of said print document outside said sections, and using said preset combination of exception print settings for pages of said print document within said sections.

12. The system according to claim 11, said graphic user interface providing said exception shortcut keywords and said receiving said exception shortcut keyword appearing in an application used to one of create and edit said print document.

13. The system according to claim 12, said preset combination of exception print settings comprising print setting outside those natively available in said application used to one of create and edit said print document.

14. The system according to claim 11, said graphic user interface providing said exception shortcut keywords and said receiving said exception shortcut keyword appearing in a print job submission application used after said print document has been previously created.

15. (canceled)

16. A system comprising:
a graphic user interface receiving identification of sections of a print document, and said receiving identification of said sections being performed without identification of page numbers within said print document;
a processor operatively connected to said graphic user interface; and
a printing device operatively connected to said processor,
said print document having document print settings,
said graphic user interface providing exception shortcut keywords from a print driver,
each of said exception shortcut keywords identifying a preset combination of exception print settings,
each of said preset combination of exception print settings being different from said document print settings,
each different one of said preset combination of exception print settings maintained by said print driver comprising a different combination of print media, printing color, color correction, image shift, printing image quality, and simplex/duplex controls,
said graphic user interface receiving an exception shortcut keyword for at least one of said sections without identification of page numbers, providing dynamic section-based page override page exception independent of page numbers,
said processor automatically changing print settings of corresponding ones of said sections of said print document to corresponding ones of said preset combination of exception print settings in response only to said receiving said exception shortcut keyword using said print driver, and
said printing device printing said print document using said document print settings for pages of said print document outside said sections, and using said preset combination of exception print settings for pages of said print document within said sections.

17. The system according to claim 16, said graphic user interface providing said exception shortcut keywords and said receiving said exception shortcut keyword appearing in an application used to one of create and edit said print document.

18. The system according to claim 17, said preset combination of exception print settings comprising print setting outside those natively available in said application used to one of create and edit said print document.

19. The system according to claim 16, said graphic user interface providing said exception shortcut keywords and said receiving said exception shortcut keyword appearing in a print job submission application used after said print document has been previously created.

20. (canceled)
